(19) United States
(12) Patent Application Publication
(10) Pub. No.: US 2010/0274756 A1
(43) Pub. Date: Oct. 28, 2010

(54) MULTIDIMENSIONAL DATA ANALYSIS METHOD, MULTIDIMENSIONAL DATA ANALYSIS APPARATUS, AND PROGRAM

(76) Inventors: Akihiro Inokuchi, Osaka (JP); Kiyoto Takabayashi, Osaka (JP); Takashi Washio, Osaka (JP)

Correspondence Address: WENDEROTH, LIND & PONACK, L.L.P., 1030 15th Street, N.W.,, Suite 400 East, Washington, DC, 20005-1503, US

(21) Appl. No.: 12/743,585

(22) PCT Filed: Nov. 18, 2008
(86) PCT No.: PCT/JP2008/003366

§ 371 Date: May 19, 2010

(30) Foreign Application Priority Data
Nov. 20, 2007 (JP) 2007-301025

(51) Int. Cl. G06F 17/30

(52) U.S. Cl. 707/602; 707/E17.054

(57) ABSTRACT

A highly-usable multidimensional data analysis method for performing interactive analysis on, for example, medical/administrative data stored in a hospital information system to support knowledge discovery about clinical decision-making is proposed. A multidimensional data analysis apparatus (200) includes: a database (201) separately holding an interval table I indicating intervals and a hierarchy table T indicating a hierarchical structure of each dimension of multidimensional data; an interval selection operation unit (202c) selecting an interval I′ having a user-requested property c from the interval table I, using an interval selection operation g; a join operation unit (202b) joining a set of intervals with a join operation (3 in the interval selected by the interval selection operation unit (202c), using the join operation β; and an aggregation operation unit (202a) generating a multidimensional cube from a result in the join operation unit (202b), using an aggregation operation α.

### TECHNICAL FIELD

The present invention relates to a multidimensional data analysis method, a multidimensional data analysis apparatus, and a program for performing multidimensional analysis of time series data in which dimensions and events are in a many-to-many relationship.

### BACKGROUND ART

In recent years, remarkable progress of computer environments and surrounding network technologies and development of basic technologies such as middleware typified by databases contribute to improvements in techniques of storing and managing enormous amounts of information. In addition, the Ministry of Health, Labor and Welfare has formulated a “Grand Design for Informatization of Medical, Healthcare, Nursing Care and Welfare Domains” (see Non-patent Reference 15), stimulating introduction of electronic medical record systems gradually. As a result, systems for storing medical and administrative data are becoming increasingly common to improve medical care service efficiency.

Meanwhile, there are growing expectations toward information management techniques that enhance intellectual productivity and analysis techniques that allow for new knowledge discovery by utilizing enormous amounts of information stored on a daily basis. As recent situations surrounding medical care, financial stringency in medical insurance system due to increasing national medical expenditure and an aging population with fewer children, combined with increasingly IT-oriented public services as represented by the e-Japan Strategy, raises a need for hospital management reforms using information systems (see Non-patent Reference 9).

Currently, medical information systems are introduced, though gradually, along the Grand Design for Informatization of Medical Domains, and there are some signs of improved efficiency in medical care and hospital management services. Enhancement of medical transparency has brought success in reassuring patients.

However, even when enormous amounts of medical information are stored, techniques of utilizing such medical information in order to increase management efficiency and establish evidence-based medicine (EBM) still have room for improvement.

In detail, medical information data includes time series data of medical care, testing, medication, surgery, and the like of patients, and each item has an extremely complex hierarchical structure and is managed as master data. Each patient receives different medical care, surgery, medication, and/or testing a plurality of times in different medical departments. Analyzing these data contributes to more detailed analysis of medical processes, evaluation of critical paths (clinical paths), and so on (see Non-patent Reference 9). However, it is not easy to perform analysis by a data mining technique of fully searching a possible hypothesis space in order to find a problem from a whole database which is large and complex. It is more realistic to perform such analysis that narrows down an item of the user's interest interactively or by trial and error, in terms of a computer processing capability too.

Interactive analysis is also effective as a process of finding a problem from data having a complex structure. In the field of databases, a multidimensional database is used as a technique of interactively analyzing time series data (see Non-patent References 1, 2, 4, 6, and 11).

The multidimensional database treats data as a set of events having measures and dimensions. For example, in retail sales data, each purchase history is a fact, an amount and a price are measures, and a product type, a purchase time, a purchase location, and the like are dimensions. A process of performing search, extraction, and processing on enormous amounts of original data, storing in a multidimensional database, and outputting a result is called Online Analytical Processing (OLAP). Each dimension of the multidimensional database has a hierarchical structure, so that data can be selected/aggregated at a data granularity corresponding to a processing request.

For instance, there is a purchase history example as a typical example of analysis in a conventional multidimensional database. In each store, information on which products are sold and when, where, and how much the products are sold are stored in a database, and a sales total and the like are aggregated in a three-dimensional database as shown in FIG. 15.

FIG. 15 shows an example of a multidimensional cube 1500. Though a purchase location axis (dimension) in the example shown in FIG. 15 indicates aggregations at a city level, the dimension has a hierarchy, and interactive analysis can be performed at a granularity corresponding to the user's purpose of analysis, such as a prefecture level or a region (Kanto, Kansai, and so on) level.

Non-patent Reference 1: S. Agarwal, R. Agrawal, P. Deshpande, A. Gupta, J. F. Naughton, R. Ramakrishnan, and S. Sarawagi, On the Computation of Multidimensional Aggregates, Proc. of International Conference on Very Large Data Bases, pp. 506-521, 1996

Non-patent Reference 2: P. Baumann, A. Dehmel, P. Furtado, R. Ritsch, and N. Widmann, Spatia-Temporal Retrieval with RasDaMan, Proc. of International Conference on Very Large Data Bases, pp. 746-749, 1999

Non-patent Reference 3: P. F. Dietz, Maintaining order in a linked list, Proc. of Annual ACM Symposium on Theory of Computing, pp. 122-127, 1982

Non-patent Reference 4: S. Goil and A. N. Choudhary, High Performance Multi-dimensional Analysis of Large Datasets, Proc. of International Workshop on Data Warehousing and OLAP, pp. 34-39, 1998

Non-patent Reference 5: H. Gupta, V. Harinarayan, A. Rajaraman, and J. D. Ullman, Index Selection for OLAP, Proc. of International Conference on Data Engineering, pp. 208-219, 1997

Non-patent Reference 6: M. Gyssens and L. Lakshmanan, A Foundation for Multi-dimensional Databases, Proc. of International Conference on Very Large Data Bases, pp. 106-115, 1997

Non-patent Reference 7: A. Inokuchi, K. Takeda, N. Inaoka, and F. Wakao, MedTAKMI-CDI: Interactive knowledge discovery for clinical decision intelligence, IBM Systems Journal, Volume 46, Number 1, pp. 115-134, 2007

Non-patent Reference 8: A. Inokuchi and K. Takeda, A Method for Online Analytical Processing of Text Data, Proceedings of ACM Conference on Information and Knowledge Management (CIKM 2007), 2007 (to appear)

Non-patent Reference 9: Y. Kinosada, T. Umemoto, A. Inokuchi, K. Takeda, and N. Inaoka, Challenge to Analysis for Clinical Processes by Using Mining Technology, Japan Journal of Medical Informatics, Vol. 26, No. 3, pp. 191-199, 2006

Non-patent Reference 10: T. Pedersen and C. Jensen, Multidimensional Data Modeling for Complex Data, Proceedings of the 15th International Conference on Data Engineering, pp. 336-345, 1999

Non-patent Reference 11: T. B. Pedersen and C. S. Jensen, Multidimensional Database Technology, IEEE Computer, Vol. 34, No. 12, pp. 40-46, 2001

Non-patent Reference 12: F. Wakao, B. K. Ishikawa, N. Inaoka, A. Inokuchi, and S. Suzuki, A Study on Clinical Process Analysis System for Cancer, the 25th Joint Conference on Medical Informatics, 2-F-6-6, 2005

Non-patent Reference 13: L. Wang, A. Zhang, and M. Ramanathan, BioStar Models of Clinical and Genomic Data for Biomedical Data Warehouse Design, International Journal of Bioinformatics Research and Applications, Vol. 1, No. 1, pp. 63-80, 2005

Non-patent Reference 14: T. Igarashi, T. Ashihara, S. Nagata, M. Takada, and K. Nakazawa, A Pen-based Interface for Electronic Medical Recording Systems, Japan Journal of Medical Informatics, Vol. 20, No. 2, pp. 482-483, 2000

Non-patent Reference 15: the Ministry of Health, Labor and Welfare, a Grand Design for Informatization of Medical, Healthcare, Care and Welfare Domains, http://www.mhlw.go.jp/houdou/2007/03/h0327-3.html.

Non-patent Reference 16: M. Nishibori and S. Shiina, Developing the Ideal User Interface for the Medical Information System, Japan Journal of Medical Informatics, Vol. 10, No. 1, pp. 3-14, 1990

Non-patent Reference 17: Y. Yamanobe, S. Aizawa, and M. Honda, GUI Problems in Electronic Medical Record Systems, IT Health Care, Vol. 2, No. 1, pp. 28-31, 2007. 8

### DISCLOSURE OF INVENTION

### Problems that Invention is to Solve

However, in the case of analyzing, for example, medical data in electronic medical records using the above-mentioned existing multidimensional database, due to characteristics of medical information data, it is difficult to store data by a schema used in the conventional multidimensional database, and also a temporal order of data needs to be taken into consideration at the time of analysis. Hence, a new method for modeling and analyzing more complex data than purchase history data and the like which have been much studied thus far is necessary.

That is, when analyzing medical information data using conventional OLAP, the conventional OLAP has the following four problems with regard to the medical information data.

Firstly, in a multidimensional database by a star schema, facts and dimensions are in a 1-to-n relationship. However, medical histories do not necessarily have a 1-to-n relationship but often have an n-to-m relationship. In detail, in retail sales data analysis, one purchase history which is a fact is associated with only one dimension value in each dimension such as a product type, a purchase time, and so a purchase location. On the other hand, in the case of medical histories where a history of one patient is set as a fact and medical care, surgery, medication, and test data are set as dimensions, a plurality of dimension values in each dimension exist for one fact, and a plurality of facts correspond to an item which can be a dimension. This cannot be supported by the conventional star schema. Although data can be stored in the star schema if one hospital stay is treated as a fact and a “main” disease name, a “main” surgical operation, and the like are treated as dimensions, this makes it difficult to perform analysis involving both outpatients and inpatients and analysis across a plurality of hospital stays.

Secondly, in medical information data, a temporal order of events has an important meaning, and an analytical query needs to be made in consideration of an order of events. In detail, for a patient with larynx cancer, the case of reducing tumor size by chemotherapy or radiation therapy before performing surgery and the case of applying chemotherapy or radiation therapy to prevent cancer recurrence after performing surgery need to be perceived as different medical processes.

Thirdly, since complex conditions are combined in a query in consideration of the problems mentioned above, efficient processing for interactive analysis is necessary. However, it is difficult to apply a form such as MOLAP that requires pre-aggregation, to medical data having many types of items which can be dimensions.

Fourthly, to execute such complex processing, a complex query needs to be provided using a query language such as SQL. Assuming that the user is a healthcare professional unfamiliar with SQL, an intuitively operable user interface is necessary in order to perform interactive analysis.

Thus, while individual purchases can be treated as separate records, each test history, surgery history, admission-discharge history, disease history, and the like of electronic medical records constitute a series of data for one patient, with there being a problem that sufficient analysis cannot be performed due to differences in data characteristics. In the case of purchase histories, one purchase record is associated with one purchase location, one purchase time, and one product type that belong to different dimensions. In the case of medical data, on the other hand, each item is associated with a plurality of test histories, surgery histories, admission-discharge histories, and disease histories, for a patient. Although there is an example of associating with one set of main data such as a main disease name, a main surgical operation, whether or not tested, and the like to perform analysis using a commercial system, sufficient analysis is impossible in this case.

A technique by Pedersen described later has a difficulty of performing analysis in consideration of an order of medical processes. Besides, a technique called Biostar (see Non-patent Reference 7) mainly proposes a data storage method, while leaving, to the user, a procedure (operation) for obtaining an analysis result desired by the user. Furthermore, a technique of MedTAKMI-CDI (see Non-patent Reference 13) holds data on the basis of events, but has poor efficiency. This technique also lacks extensibility and flexibility because individual features are implemented separately.

The present invention has been made in view of the problems described above, and has an object of providing a multidimensional data analysis method having a data model and a table schema that ease handling of a temporal order by treating data, such as medical information data which is difficult to be flexibly analyzed by the conventional OLAP, as interval data having information of start times and end times of events.

Moreover, the present invention has an object of providing a multidimensional data analysis method whereby various queries of the user can be handled uniformly.

Furthermore, the present invention has an object of providing a multidimensional data analysis method having a user interface that allows the user's purpose of analysis to be intuitively expressed to thereby execute the analysis easily.

### Means to Solve the Problems

To solve the problems described above, a multidimensional data analysis method according to the present invention is a multidimensional data analysis method for performing multidimensional analysis of time series data in which dimensions and events are in a many-to-many relationship, the multidimensional data analysis method including: holding an interval table I and a hierarchy table T separately in a database, the interval table I indicating intervals having information of start times and end times of the events, and the hierarchy table T indicating a hierarchical structure of each dimension of multidimensional data; selecting an interval having a property β requested by a user from the interval table I, by using an interval selection operation g which is an operation of returning a table indicating an interval; joining a set of intervals with a join operation β in the interval I′ selected in the selecting, by using the join operation β which is an operation of joining the interval I′ with a predetermined join condition; and generating a multidimensional cube from a result of the joining, by using an aggregation operation a which is an operation of generating a multidimensional cube of n dimensions from a data table.

According to this structure, data is treated as interval data having information of start times and end times of events, by using the interval table I. Thus, it is possible to provide a multidimensional data analysis method having a data model and a table schema that ease handling of a temporal order, whereby various queries of the user can be handled uniformly through the use of the interval selection operation g, the join operation β, and the aggregation operation α.

Moreover, the multidimensional data analysis method according to the present invention further includes: receiving an input command from the user; and displaying the multidimensional cube generated in the generating and a user interface used in a user operation in the receiving, on a screen, wherein, in the user interface displayed in the displaying, a left side and a right side of a rectangle object are set as a start time and an end time of an interval, connecting two intervals of different rectangle objects with a line designates a temporal order of the intervals, and connecting the rectangle objects to an aggregation operation rectangle object with a line inputs the aggregation operation.

According to this structure, the user performs interactive analysis using the user interface in the input step. Since the user interface can be operated even by the user such as a healthcare professional unfamiliar with operators and programming, it is possible to provide a multidimensional data analysis method that allows the user's purpose of analysis to be intuitively expressed to thereby execute the analysis easily.

Note that, to achieve the stated objects, the present invention may also be realized as a multidimensional data analysis apparatus including units corresponding to the characteristic steps of the multidimensional data analysis method, or as a program causing a computer to execute each of the steps. Such a program may be distributed via a recording medium such as a CD-ROM or a transmission medium such as the Internet.

### EFFECTS OF THE INVENTION

In the multidimensional data analysis method according to the present invention, a data model and a table schema that ease handling of a temporal order can be realized by treating data as interval data having information of start times and end times of events. Moreover, data operations that enable various queries of the user to be handled uniformly can be provided. Furthermore, a user interface that allows the user's purpose of analysis to be intuitively expressed to thereby execute the analysis easily can be provided.

### BRIEF DESCRIPTION OF DRAWINGS

FIG. 1 is an explanatory diagram of data analysis by a multidimensional data analysis apparatus according to the present invention.

FIG. 2 is a diagram showing an example of functional blocks of the multidimensional data analysis apparatus according to the present invention.

FIG. 3 is a flowchart showing an operational procedure of an operation unit in the multidimensional data analysis apparatus according to the present invention.

FIG. 4 is a reference diagram showing a part of the International Classification of Diseases.

FIG. 5 is a reference diagram showing a function g.

FIG. 6 is a reference diagram showing an output image of a query example 1.

FIG. 7 is a reference diagram showing an output image of a query example 2.

FIG. 8 is a reference diagram showing an output image of a query example 3.

FIG. 9 is a reference diagram showing an output image of a query example 4.

FIG. 10 is a reference diagram showing an output image of a query example 5.

In FIG. 11, (a) is a reference diagram showing an object that represents an interval on a GUI, and (b) is a reference diagram showing a relationship between two intervals.

In FIG. 12, (a) and (b) are reference diagrams respectively showing query descriptions of the query examples 1 and 2.

FIG. 13 is a reference diagram showing an example of applying the present invention using pseudo data.

FIG. 14 is a reference diagram showing a table schema of BioStar.

FIG. 15 is an explanatory diagram of conventional OLAP.

### NUMERICAL REFERENCES

200 Multidimensional data analysis apparatus
201 Database
202 Operation unit
202a Aggregation operation unit
202b Join operation unit
202c Interval selection operation unit
203 Display unit
204 Input unit
400 International Classification of Diseases
500 User-defined function

### BEST MODE FOR CARRYING OUT THE INVENTION

The following describes an embodiment of a multidimensional data analysis method according to the present invention, with reference to drawings.

### Embodiment

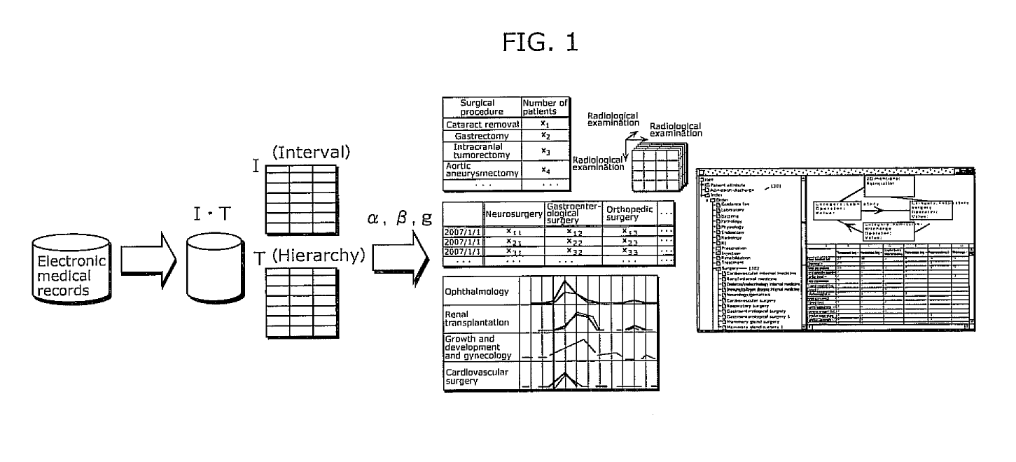

FIG. 1 is an explanatory diagram of data analysis by a multidimensional data analysis apparatus according to the present invention.

In the multidimensional data analysis method according to the present invention, for example, medical data such as electronic medical records is stored in a database in a state of being separated between a table I indicating intervals having information of start times and end times of events and a hierarchy table T indicating a hierarchical structure of each dimension of multidimensional data. For example, the table I holds admission-discharge periods, disease periods, surgery periods, and the like of patients, and the table T holds a surgical procedure hierarchy, a disease hierarchy (ICD: International Classification of Diseases), and the like. Through the use of each of an interval selection operation g, a join operation β, and an aggregation operation a described later, a search result requested by the user can be displayed as a multidimensional cube.

Moreover, as shown in FIGS. 11 to 13 described later, the user can perform data search by desired search criteria using rectangle objects representing intervals. In a user interface according to the present invention, a left side and a right side of a rectangle object are set as a start time and an end time of an interval. By connecting two intervals with a line, a temporal order is designated for the intervals. In addition, by connecting a line to an aggregation operation rectangle object, an aggregation operation can be inputted.

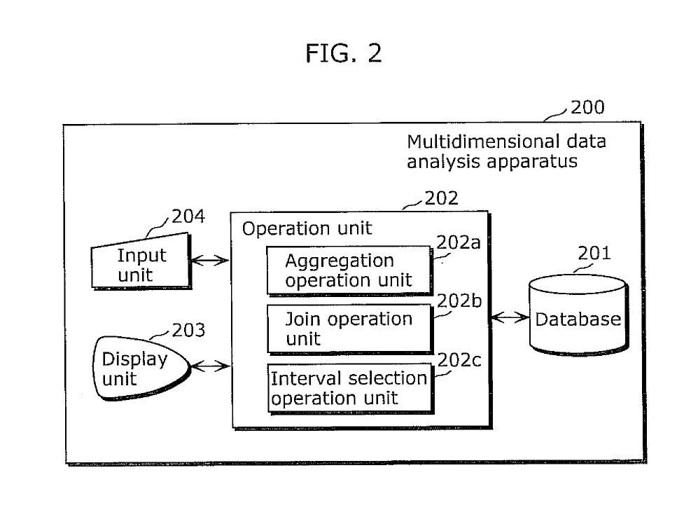

FIG. 2 is a diagram showing an example of functional blocks of the multidimensional data analysis apparatus according to the present invention.

A multidimensional data analysis apparatus 200 includes: a database 201 in which the interval table I and the hierarchy table T using electronic medical record information are held separately; an operation unit 202 including an aggregation operation unit 202a, a join operation unit 202b, and an interval selection operation unit 202c; a display unit 203 that displays a multidimensional cube as an operation result of the operation unit 202 and a user interface operated through an input unit 204; and the input unit 204 which is an operation input unit such as a keyboard.

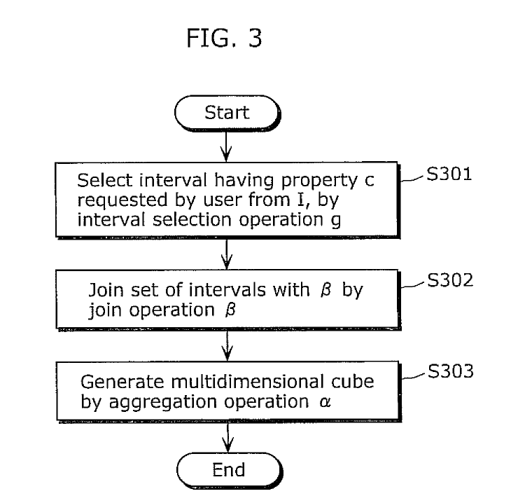

FIG. 3 is a flowchart showing an operational procedure of the operation unit in the multidimensional data analysis apparatus according to the present invention.

First, the interval selection operation unit 202c selects an interval I′=g(I, T, c) having a property c requested by the user from I, by the interval selection operation g (Step S301). Following this, the join operation unit 202b joins a set of intervals with β({I′1, . . . , I′n}, O, W)=no(σp(I′1× . . . I′n)), by the join operation β (Step S302). Here, W and O are columns of selection conditions and outputs. Lastly, the aggregation operation unit 202a generates a multidimensional cube by the aggregation operation a (Step S303). The generated multidimensional cube is displayed by the display unit 203.

The following describes the multidimensional data analysis method according to the present invention in more detail.

First, when defining the technique proposed in the present invention in accordance with the references (see Non-patent References 8 and 10), analysis target data D is defined as D={(fi, {pᵢ₁; pᵢ₂, . . . pᵢₘ})} (i=1; 2, . . . , n).

Here, {fi|i=1; 2, . . . n} is a set of patient IDs, and pᵢⱼ is interval information. Moreover, (fi; {pᵢ₁, pᵢ₂, . . . pᵢₘ}) means each patient fᵢ has a set of interval-related information pᵢⱼ.

An interval is defined as pᵢⱼ=(tₛ, tₑ, {c: v}), where tₛ and tₑ respectively denote a start time and an end time of the interval. In particular, when tₛ=tₑ, the interval pᵢⱼ is called an event. v is a value describing the interval, and c is a category to which the value v belongs. c is also a node in data having a hierarchy.

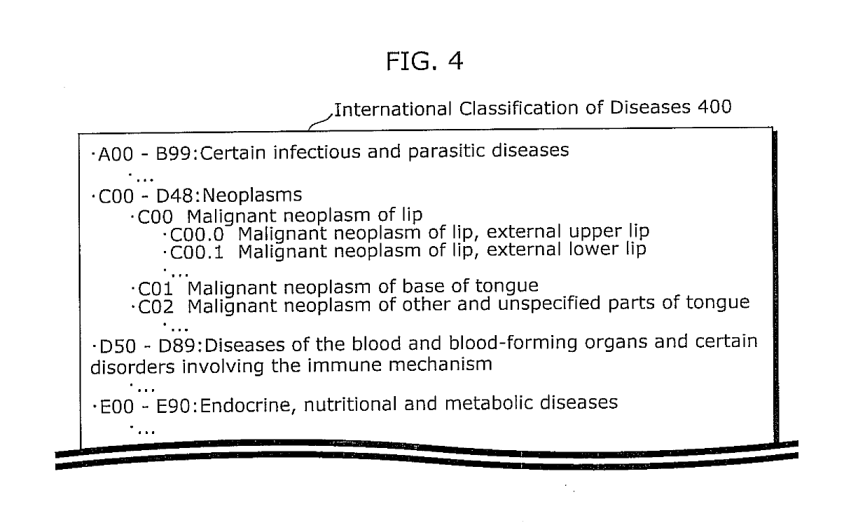

In more detail, when {pᵢⱼ} is an interval (time period) relating to admission-discharge, c: v includes a disease name, an attending doctor, and the like during the hospital stay. An International Classification of Diseases (ICD) 400 having a hierarchical structure as shown in FIG. 4 is used for categories of disease names. Since the number of disease names during a hospital stay is not necessarily limited to one, there is a possibility that c: v having the same c but different v may exist. When p_{if} relates to surgery, c: v includes a surgical procedure, a surgical site, a surgeon, and the like, where categories of surgeons are hierarchized according to, for example, their departments. In a conventional OLAP system, c and v are not distinguished from each other. In the present invention, on the other hand, c and v are distinguished from each other, as c is treated as a white blood cell count test item in a laboratory test and v is treated as a test value. Note that c does not need to be a lowest node in a category hierarchy, and may be an internal node.

Given a hierarchy set D={Tk}, a schema is defined as S=(F; D) where F is a fact type and Tk is a hierarchy type Tk=(Cl; <_Tk). A hierarchy instance Tk of the type Tk is Tk=(Ck; <_Tk). Here, Ck denotes a set of categories cj, and <_Tk denotes a partial order relation between Ck.

A hierarchy used in the present invention does not need to be a balanced tree adopted in many conventional OLAP systems, and a Directed Acyclic Graph (DAG) is assumed (see Non-patent Reference 8). Each category cεC has a domain dom(c), and each element of dom(c) is expressed as {c: v} as mentioned earlier.

To increase a computation speed of the aggregation operation, the hierarchy is indexed as follows. An artificial root node cᵣₒₐₜ is given as a parent node of cj having no higher concept in C. Starting at cᵣₒₒₜ, depth first search is performed while assigning a preorder, a postorder, and a depth to each node. Note that the search does not backtrack at internal nodes, and backtracks only at leaf nodes. Determination on whether or not an input category c and a category of data are in a descendant relationship can be easily made by the following condition. When a node A is an ancestor of a node B, the following expression (1) holds (see Non-patent Reference 3).

A's preorder1(=preorder of A)<preorder of B≦A's preorder2=postorder of A+depth of A [Expression 1]

To store hierarchical relationships and interval information, the tables CATEGORY T and INTERVAL I are defined as follows.

| | | |
|---|---|---|
| CATEGORY | (CATENAME | CHARACTER, |
| | PATH | CHARACTER, |
| | PREORDER1 | INTEGER, |
| | PREORDER2 | INTEGER, |
| | PARENT | INTEGER) |
| INTERVAL | (ID | INTEGER, |
| | START | TIMESTAMP, |
| | END | TIMESTAMP, |
| | PREORDER | INTEGER, |
| | VALUE | CHARACTER, |
| | INTERVALID | INTEGER) |

Each record of T corresponds to a different one of nodes in a hierarchy, and CATENAME, PATH, PREORDER1, PREORDER2, AND PARENT are respectively a category name of the node, a path from a root node to the node, a preorder of the node, a sum of a postorder and a depth of the node, and a preorder of a parent node.

Each record of I corresponds to information obtained by dividing (ts; te; {c: v}) by |{c: v}, and ID, START, END, PREORDER, VALUE, and INTERVALID are respectively a patient ID, an interval start time, an interval end time, a preorder of a category c, a value v in dom(c), and an interval identifier. The reason for using the interval identifier INTERVALID is that (ts; te; {c: v}) is divided by |{c: v}|.

The aggregation operation is defined as follows, using the two tables described above. In the following definition, Tc denotes “σp(T) FETCH FIRST 1 ROWS ONLY” which is an SQL statement of returning one tuple of the table T for an input category.

(1) Aggregation operation a: an aggregation operation of returning α(A)=_{v1; v2, . . . , vnXv1; v2; . . . ; vn; count(distince it) for a tble A (v}1, v2, vn, id) is defined as σ(A). It can be understood that the operation σ is a function of generating a multidimensional cube of n dimensions from the table A.

(2) Join operation β: the join operation β is defined as β({I′₁, I′₂; . . . ; I′ₙ}; O; W)=πₒ(I′₁×I′₂× . . . ×I′ₙ). Here, each table I′i is an interval I′(id; start; end; value; interval_id). W is a set of join condition expressions, and I′i× . . . ×I′j are joined according to the condition expressions W and I′i.id=I′j.id. O is a set of columns outputted.

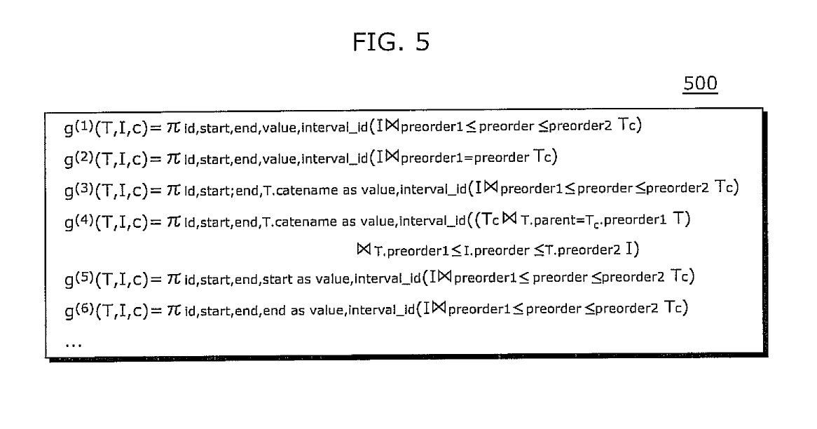

(3) Interval selection operation g: the interval selection operation g(T; I; c) is defined as an operation of returning a table I′(id; start; end; value; interval_id) indicating an interval. The function g is a user-defined function 500 (see Non-patent Reference 8) defined according to a purpose of analysis. FIG. 5 shows an example of the function 500. g⁽¹⁾ is an operation of selecting an interval that has v belonging to a designated category c and its descendant category. g⁽²⁾ is an operation of selecting an interval that has v belonging to the designated category c.

g⁽³⁾ is an operation of selecting the same interval as g⁽¹⁾ where v is replaced with CATEGORYNAME in the table T. g⁽⁴⁾ is an operation of selecting the same interval as g⁽¹⁾ where v is replaced with CATEGORYNAME of the child category of the designated category c. g⁽⁵⁾ is an operation of selecting the same interval as g⁽¹⁾ where v is replaced with an interval start time.

Specific examples are given below to show what kind of aggregation can be performed by the operations described above.

(1) A query example 1 is expressed using an expression (2).

α(β({g⁽¹⁾(T,I,c₁),g⁽¹⁾(T,I,c₂)},O₁,W₁)) [Expression 2]

Let c₁ and c₂ be a surgery category and an admission-discharge category respectively, and an expression (3) is given.

O₁={I′₁·value,id},

W₁={I′₂·start≦I′₁·start,I′₁·end≦I′₂·end} [Expression 3]

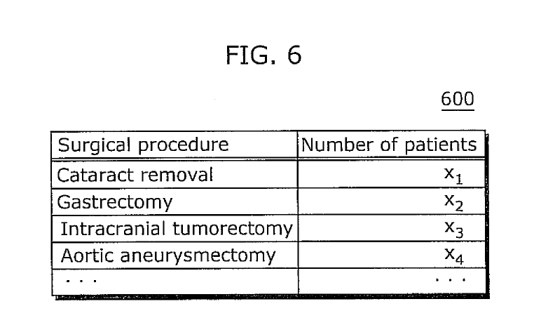

The above query returns a result of aggregating the number of patients undergoing surgery during a hospital stay, for each surgical procedure. An output image is shown in FIG. 6. FIG. 6 is a reference diagram showing an output image 600 of the query example 1.

(2) A query example 2 is expressed using an expression (4).

α(β({g⁽⁴⁾(T,I,c₁),g⁽¹⁾(T,I,c₂),g⁽¹⁾(T,I,c₃)},O₂,P₂)) [Expression 4]

Let c₁, c₂, and c₃ be a surgery category, an admission-discharge category, and a radiological examination (X-ray, CT, MRI) category respectively, and an expression (5) is given.

O₂={date(I′₁·start),I′₁value,id},

W₂={I′2start≦I′₃·start,I′₃·end≦I′₂·end} [Expression 5]

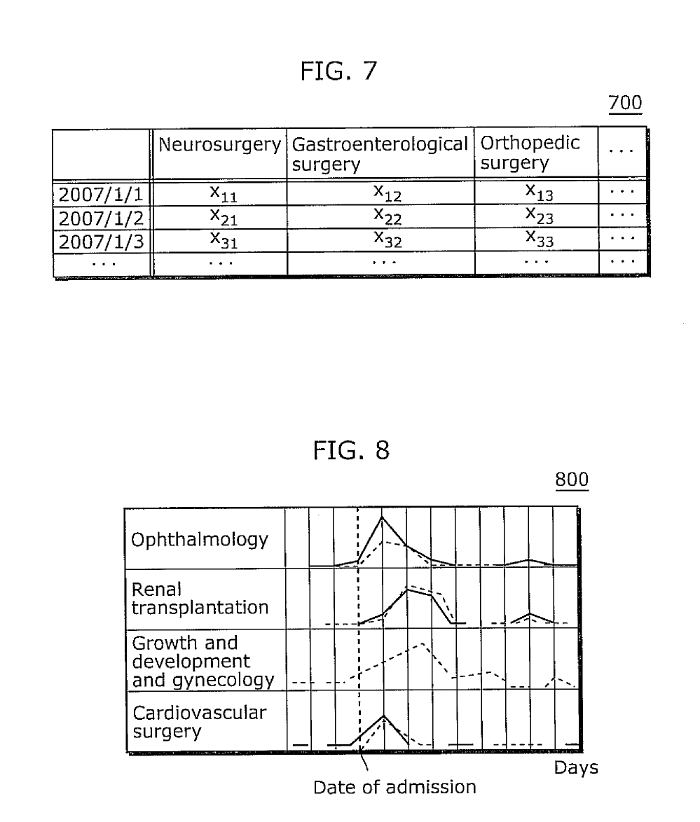

The above query returns a result of aggregating the number of patients undergoing a radiological examination and surgery “in this order” during a hospital stay, for each department of surgery and for each surgery date. An output image 700 is shown in FIG. 7. It is assumed here that data relating to surgery is held as surgical procedures in the table I, and departments suitable for the surgical procedures are provided at a higher hierarchical level than the surgical procedures. FIG. 7 shows a roll-up from the aggregation for each surgical procedure to the aggregation for each department.

(3) A query example 3 is expressed using an expression (6)

α(β({g⁽⁴⁾)(T,I,c₁),g⁽¹⁾(T,I,c₂),g⁽¹⁾(T,I,c₄)},O₃,W₃)) [Expression 6]

Let c₁, c₂, and c₄ be a surgery category, an admission-discharge category, and a gender category respectively, and an expression (7) is given.

O₃={I′₁·value,date(I′₁·start)−date(I′₂·start),I′₃·value,interval_id},

W₃={year(I′₂·start)=2007} [Expression 7]

The above query returns a result of aggregating the number of surgical operations of patients hospitalized in 2007 for each gender and for each department, in relation to the number of days elapsed from an admission date to a surgery date. An output image 800 is shown in FIG. 8.

In FIG. 8, a vertical line indicates the admission date, a horizontal axis indicates elapsed time from left to right with respect to the admission date, and a vertical axis indicates the number of male patients (solid line) and the number of female patients (dotted line) undergoing surgery in each department at a time indicated by the horizontal axis. The condition expression year(I′₂.start)=2007 is an operation of limiting to admission-discharge periods with the admission date in 2007, and corresponds to a slice in the conventional OLAP. Moreover, while the two queries mentioned earlier aggregate the number of patients, the query example 3 aggregates the number of surgical operations. Thus, the table schema according to the present invention does not treat attributes of measures separately.

(4) A query example 4 is expressed using an expression (8).

α(β({g⁽¹⁾(T,I,c₃),g⁽¹⁾(T,I,c₃),g⁽¹⁾(T,I,c₃),g⁽¹⁾(T,I,c₂)},O₄,W₄)) [Expression 8]

Let c₃ be a radiological examination category, and an expression (9) is given.

O₃={I′₁·value,I′₂·value,I′₃·value,id},

W₄={I′₄·start≦I′₁·start<I′₂·start<I′₃·start≦I₄·end} [Expression 9]

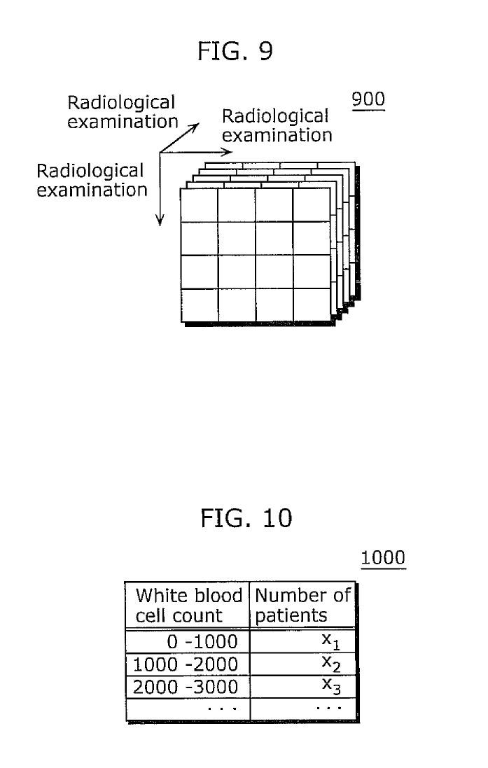

The above query is a query of aggregating the number of instances of the order of each radiological examination type, for patients undergoing a radiological examination three or more times during a hospital stay. An output image 900 is shown in FIG. 9.

As shown in FIG. 9, each dimension of the generated cube corresponds to a type of radiological examinations. In the conventional OLAP implemented by a star schema, each dimension of a cube is defined when defining a table. In the technique according to the present invention, on the other hand, each dimension of a cube is defined when generating a query. FIG. 9 is a reference diagram showing the output image 900 of the query example 4.

(5) A query example 5 is expressed using an expression (10).

α(β(β({g⁽⁷⁾(T,I,c₅)},O₅,φ))

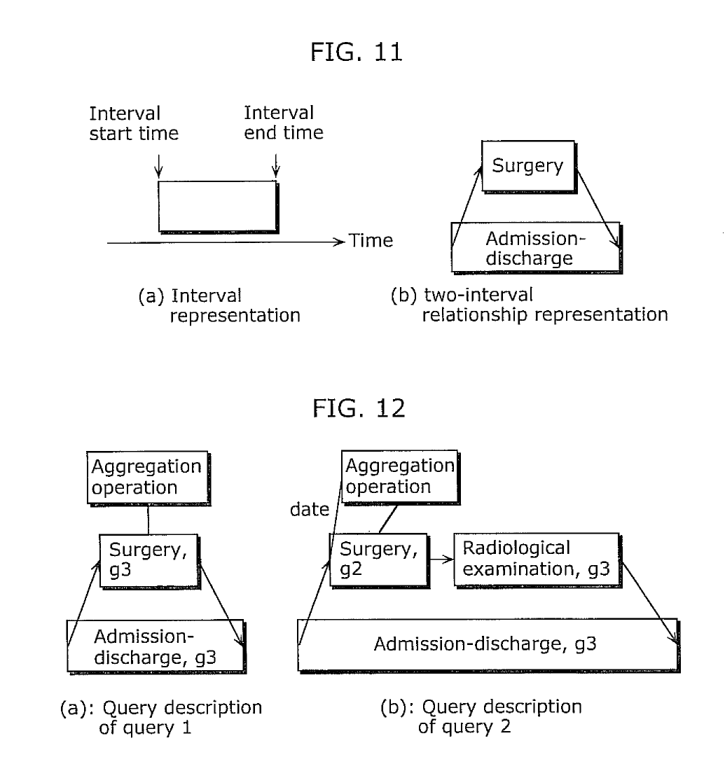

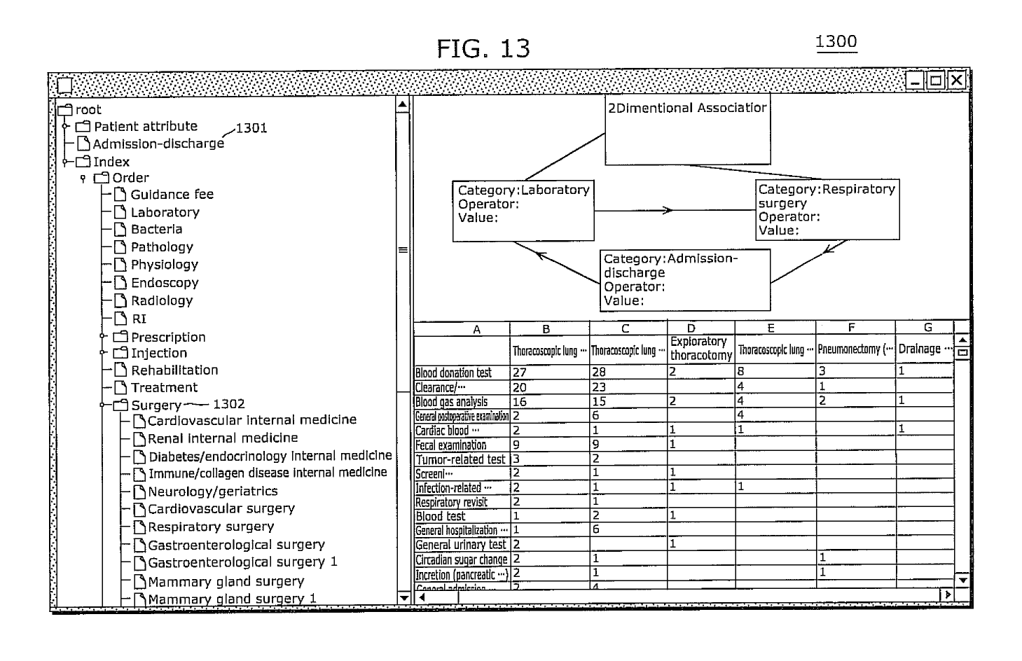

Let c₅ be a white blood cell count category, and O₅={I₁.value;id}, g⁽⁷⁾ be a function of discretizing the white blood cell count. This being the case, the above query returns a result as shown in FIG. 10. FIG. 10 is a reference diagram showing an output image 1000 of the query example 5.

The following describes the user interface used in the multidimensional data analysis apparatus according to the present invention.

In an environment where electronic medical record information is stored in a relational database, a person having experience of using SQL can obtain a desired analysis result by directly inquiring an operational system (or its replica), without using the tables described above.

However, the present invention is intended to be used by a healthcare professional having no experience of using SQL. As an example, an electronic medical record system introduced in a G university hospital contains master information over 100 and several tens of implementation tables, so that it is not easy for the user unfamiliar with SQL to express a query for obtaining a desired analysis result.

Besides, there is a difficulty in expressing the combination of the functions α, β, and g described above. In view of this, the present invention proposes a user interface that allows a query representing the user's purpose of analysis to be expressed easily.

(a) in FIG. 11 shows an object representing an interval on a GUI. A left side of a rectangle corresponds to a start time of the interval, and a right side of the rectangle corresponds to an end time of the interval. (b) in FIG. 11 shows a relationship between two intervals. A start point of a surgery interval is located after a start point of an admission-discharge interval and an end point of the admission-discharge interval is located after an end point of the surgery interval, indicating that surgery was performed during a hospital stay.

Through the use of such a user interface, the above-mentioned query examples 1 and 2 are expressed as (a) and (b) in FIG. 12, respectively. As shown in FIG. 12, a hatched rectangle represents the operation g and its input. Sides between hatched rectangles designate a relationship W between intervals. A side connected to a rectangle representing an operation is O, which is an output of the operation p and an input of the operation α.

The present invention described above is implemented in Java (registered trademark), thereby realizing HealthCube which is a system of aggregating data in a relational database through Java Database Connectivity (JDBC).

Moreover, patient medical history information 1300 is pseudo-generated using the master information of the G university hospital. FIG. 13 shows an example of applying the technique according to the present invention using such pseudo data. A left frame is a category hierarchy. An upper right frame is an interface for generating a query, and a lower right frame shows an aggregation result. FIG. 13 shows the number of patients undergoing laboratory testing followed by respiratory surgery, after admission.

In detail, each figure in the table indicates the number of patients who have undergone testing in the vertical axis and then undergone surgery in the horizontal axis. The number of patients in the pseudo data is 50,400, and the total number of intervals is 4,187,845. Most queries can be returned in several seconds, though the speed depends on the number of intervals and the number of dimensions of an aggregation result as conditions included in a query.

The following gives observations and describes related research.

Though medical information systems have been continuously discussed even before the Ministry of Health and Welfare launched the electronic medical chart development project in 1995, there is still ongoing debate about their operability and interfaces (see Non-patent References 14, 16, and 17).

Problems often cited include a lack of understanding of a use environment, a shortage of time the user can spare to use the system, a complex operational procedure, and an impossibility of reflecting flexible thinking. Similar problems are also raised with regard to medical information analysis tools. To enhance convenience and efficiency in an interactive analysis technique such as OLAP, it is important to not only improve tool operability but also enable the user to intuitively express what he/she wants to analyze so that the user's purpose is reflected on an output result. In consideration of these points, research relevant to the present invention is examined below.

As described above, according to the present invention, various types of query statements can be created in the same form by combining the operation functions α, β, and g and the tables T and I. Though the above-mentioned examples are relatively simple due to space limitations, it is possible to create a more complex query. An order relation between intervals or events created by a query does not need to be a total ordering, and may be a partial ordering. For example, even when intervals A and B are after C, it is possible to create a query that does not designate the order of the intervals A and B.

Research relevant to the present invention is described in Non-patent Reference 10. Non-patent Reference 10 presents nine requirements when analyzing medical data by OLAP, and proposes a data model addressing the nine requirements and operations associated with the data model. However, in the operations defined for generating a multidimensional cube, the same dimension cannot be selected, and so the result shown in FIG. 9 cannot be obtained.

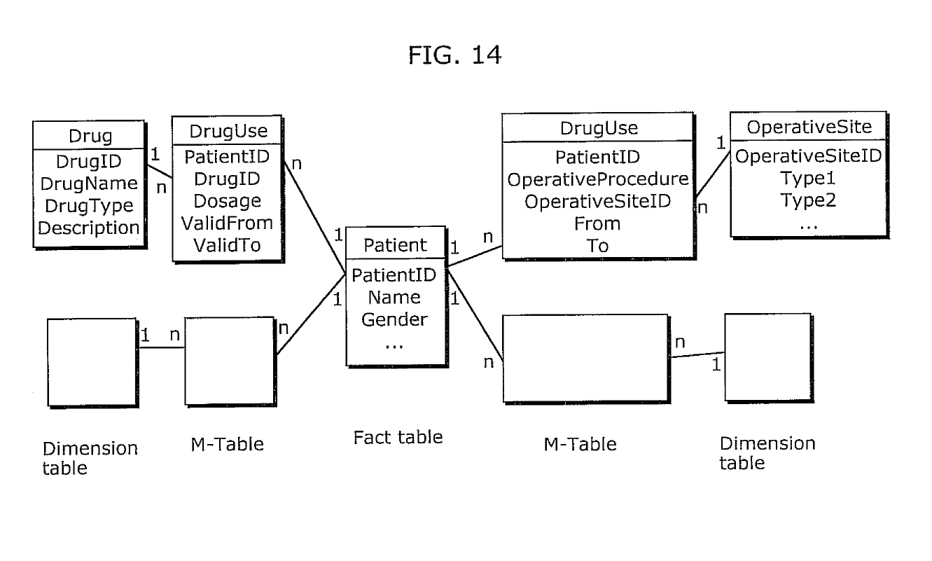

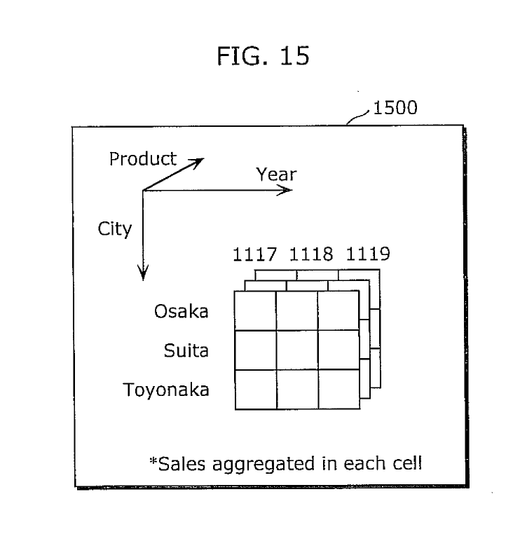

FIG. 14 is a reference diagram showing a table schema of BioStar (Non-patent Reference 13). In order to express an n-to-m relationship between patients and medication and between patients and surgery, an M-table is provided between a fact table and a dimension table, thereby enabling an n-to-m relationship to be held. In the case of surgery, however, there is a possibility that the number of surgeons is more than one. Besides, the table schema is not suitable for holding information when the number of surgeons differs depending on patient. Moreover, in medical history analysis, it is important to perform analysis in consideration of a temporal order of intervals or events as described in the embodiment, but Non-patent Reference 13 mainly describes a data storage method and does not much refer to processing for such a temporal order.

As mentioned above, an operation for obtaining surgical procedures performed during admission-discharge periods is expressed by an expression (11).

β({g⁽¹⁾(T,I,c₁),g⁽¹⁾(T,I,c₂)},O₁W₁)=πo(g⁽¹⁾(c₁) [symbol] wg⁽¹⁾(c₂)) [Expression 11]

Here, c₁ and c₂ are respectively a surgery category and an admission-discharge category, and an expression (12) is given.

O₁={I′₁·value,id},

W₁={I′₂·start≦I′₁·start,I′₁·end≦I′₂·end} [Expression 12]

Moreover, part of T and I is omitted for the sake of convenience. On the other hand, MedTAKMI-CDI (see Non-patent Reference 7) is a technique proposed to solve part of the problems listed above, too. In MedTAKMI-CDT, data is held not in units of intervals but in units of events. Therefore, in the case of an admission-discharge interval, data is held as an admission event and a discharge event having event times. According to MedTAKMI-CDI, an operation of obtaining surgical procedures performed during admission-discharge periods is expressed by an expression (13).

πo₃(πo₂(GXo₁(g⁽¹⁾(c₂) [symbol] _{P1}g⁽¹⁾(c₃))) [symbol] _{P2}g⁽¹⁾(c₁))

Here, c₁, c₂, and c₃ are respectively surgery event, admission event, and discharge event categories, and an expression (14) is given.

P₁={2·id=3·id and 2·start<3·start},

P₂={2·id=1·id and 2·start≦1·start end},

O₁={2·id,2·start,min(3·start−2·start)as min},

O₂={2·id,2·start,2·start+min as end},

O₃={1·value, G=2·start} [Expression 14]

Here, i.start is a column name returned from g⁽¹⁾(c₁). When comparing the queries (2) and (3), the query (2) requires one join, whereas the query (3) requires two joins and one aggregation. Since g(ci)× . . . × p g(cj) joins tables having tuples as many as tuples held in a fact table of a star schema, it is clear that the latter requires a more computation time.

Furthermore, while the present invention enables various analysis requests to be generated by the operations α, β, and g and the aggregations such as FIGS. 6, 7, and 8 to be performed by queries of the same form, MedTAKMI-CDI is implemented according to each feature and so cannot generate queries in the same form.

As described above, in the multidimensional data analysis method according to the present invention, a multidimensional cube can be generated in consideration of a temporal order of intervals or events that cannot be sufficiently analyzed in conventional techniques, and also various queries can be expressed by the combination of the operations α, β, and g. Moreover, an intuitive interface capable of generating queries supporting interactive analysis can be provided.

Accordingly, for example, for medical data and administrative data stored in a hospital information system, various types of query statements can be generated by combining tables and operation functions incorporating the concept of interval data, with it being possible to perform flexible analysis in an interactive manner.

In addition, by analyzing past medical history data using the multidimensional data analysis method according to the present invention, medical care quality can be improved and evaluated. Furthermore, in the case where hospital management needs to be reviewed due to modification of medical service fees and the like, the effect of improved management can be expected through comparison between departments and investigation into causes of prolonged hospitalizations.

Note that, though the present invention has been described on the basis of medical information data, the present invention is versatile and applicable to different types of data.

### INDUSTRIAL APPLICABILITY

The multidimensional data analysis method according to the present invention can be used for medical process analysis and clinical path quantitative evaluation, when applied to medical data of electronic medical records. However, the multidimensional data analysis method according to the present invention is highly versatile and applicable not only to medical data but also to, for example, quality management and market analysis.

1. A multidimensional data analysis method for performing multidimensional analysis of time series data in which dimensions and events are in a many-to-many relationship, said multidimensional data analysis method comprising:
holding an interval table I and a hierarchy table T separately in a database, the interval table I indicating intervals having information of start times and end times of the events, and the hierarchy table T indicating a hierarchical structure of each dimension of multidimensional data;
selecting an interval I′ having a property c requested by a user from the interval table I, by using an interval selection operation g which is an operation of returning a table indicating an interval;
joining a set of intervals with a join operation β in the interval I′ selected in said selecting, by using the join operation which is an operation of joining the interval I′ with a predetermined join condition; and
generating a multidimensional cube from a result of said joining, by using an aggregation operation a which is an operation of generating a multidimensional cube of n dimensions from a data table.

2. The multidimensional data analysis method according to claim 1,
wherein the aggregation operation α in said generating is defined as an operation of returning α(A)=_{v1;v2, . . . vnχv1;v2; . . . ;vn;count(distinct id)} for a table A(v₁, v₂, . . . , vₙ, id).

3. The multidimensional data analysis method according to claim 1,
wherein the join operation β in said joining is defined as β({I′1, . . . I′n}, O, W)=πo(σp(I′1× . . . ×I′n)), where each table I′i is an interval I′(id; start; end; value; interval_id), W is a set of join condition expressions, (I′i× . . . ×I′j) are joined according to the condition expressions W and I′i.id=I′j.id, and O is a set of columns outputted.

4. The multidimensional data analysis method according to claim 1,
wherein the interval selection operation g in said selecting is a user-defined function defined according to a purpose of analysis, and is defined as an operation of returning a table (id; start; end; value; interval_id) indicating the interval I′ having the property c requested by the user from the interval table I.

5. The multidimensional data analysis method according to claim 1, further comprising:
receiving an input command from the user; and
displaying the multidimensional cube generated in said generating and a user interface used in a user operation in said receiving, on a screen,
wherein, in the user interface displayed in said displaying, a left side and a right side of a rectangle object are set as a start time and an end time of an interval, connecting two intervals of different rectangle objects with a line designates a temporal order of the intervals, and connecting the rectangle objects to an aggregation operation rectangle object with a line inputs the aggregation operation.

6. The multidimensional data analysis method according to claim 3, further comprising;
receiving an input command from the user; and
displaying the multidimensional cube generated in said generating and a user inerface used in a user operation in said receiving, on a screen,
wherein, in the user interface displayed in said displaying, a left side and a right side of a rectangle object are set as a start time and an end time of an interval, connection two intervals of different rectangle objects with a line designates a temporal order of the intervals, and connecting the rectangle objects to an aggregation operation rectangle object with a line inputs the aggregation operation, and
in the user interface displayed in said displaying, an aggregation query is generated where the rectangle objects represent the intervals, the line between the rectangle objects represents W, and the line to the operation rectangle object represents O.

7. A multidimensional data analysis apparatus that performs multidimensional analysis of time series data in which dimensions and events are in a many-to-many relationship, said multidimensional data analysis apparatus comprising:
a database in which an interval table I and a hierarchy table T are held separately, the interval table I indicating intervals having information of start times and end times of the events, and the hierarchy table T indicating a hierarchical structure of each dimension of multidimensional data;
an interval selection operation unit configured to select an interval I′ having a property c requested by a user from the interval table I, by using an interval selection operation g which is an operation of returning a table indicating an interval;
a join operation unit configured to join a set of intervals with a join operation in the interval I′ selected by said interval selection operation unit, by using the join operation which is an operation of joining the interval I′ with a predetermined join condition; and
an aggregation operation unit configured to generate a multidimensional cube from a result of the joining by said join operation unit, by using an aggregation operation a which is an operation of generating a multidimensional cube of n dimensions from a data table.

8. The multidimensional data analysis apparatus according to claim 7, further comprising:
an input unit configured to receive an input command from the user; and
a display unit configured to display the multidimensional cube generated by said aggregation operation unit and a user interface used in a user operation by said input unit, on a screen,
wherein, in the user interface displayed by said display unit, a left side and a right side of a rectangle object are set as a start time and an end time of an interval, connecting two intervals of different rectangle objects with a line designates a temporal order of the intervals, and connecting the rectangle objects to an aggregation operation rectangle object with a line inputs the aggregation operation.

9. A program used in a multidimensional data analysis apparatus that performs multidimensional analysis of time series data in which dimensions and events are in a many-to-many relationship, said program causing a computer to execute:
holding an interval table I and a hierarchy table T separately in a database, the interval table I indicating intervals having information of start times and end times of the events, and the hierarchy table T indicating a hierarchical structure of each dimension of multidimensional data;
selecting an interval I′ having a property c requested by a user from the interval table I, by using an interval selection operation g which is an operation of returning a table indicating an interval;
joining a set of intervals with a join operation β in the interval I′ selected in said selecting, by using the join operation β which is an operation of joining the interval I′ with a predetermined join condition; and
generating a multidimensional cube from a result of said joining, by using an aggregation operation α which is an operation of generating a multidimensional cube of n dimensions from a data table.
